(19) United States
(12) Patent Application Publication
(10) Pub. No.: US 2009/0228639 A1
(43) Pub. Date: Sep. 10, 2009

(54) DATA STORAGE DEVICE AND DATA MANAGEMENT METHOD THEREOF

(75) Inventor: Wonhee CHO, Gyeonggi-do (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Gyeonggi-do (KR)

(21) Appl. No.: 12/372,876

(22) Filed: Feb. 18, 2009

(30) Foreign Application Priority Data
Mar. 6, 2008 (KR) 200821137

(51) Int. Cl. G06F 12/14; G06F 12/02; G06F 12/00

(52) U.S. Cl. 711/103; 711/163; 711/E12.001; 711/E12.008

(57) ABSTRACT

Disclosed is a data storage device including an external switch, a controller and a nonvolatile memory. The external switch selectively generates mode information in response to operation of the switch. The controller controls a recording operation of normal data and secured data in response to the mode information. The nonvolatile memory stores the normal data and the secured data in response to the controller.

### PRIORITY CLAIM

A claim of priority is made to Korean Patent Application No. 10-2008-0021137, filed on Mar. 6, 2008, in the Korean Intellectual Property Office, the subject matter of which is hereby incorporated by reference.

### SUMMARY

Embodiments of the present invention disclosed relate to nonvolatile memory devices. More particularly, the embodiments disclosed herein are directed to a data storage device using a flash memory and a data management method thereof.

Semiconductor memory devices are generally classified as volatile or nonvolatile. Volatile semiconductor memory devices have high read and write rates, but lose stored data when there is no power supply. Nonvolatile semiconductor memory devices are able to retain data even without a power supply. Thus, the nonvolatile semiconductor devices are widely used in applications requiring data retention regardless of power supply.

There are many kinds of nonvolatile semiconductor memories, such as mask read-only memories (MROMs), programmable ROMs (PROMs), erasable and programmable ROMs (EPROMs), electrically erasable and programmable ROMs (EEPROMs), flash memories, and so forth. Among the nonvolatile semiconductor memories, flash memories are often used as audio and video storage media in information processing devices (referred to as “hosts”), such as computers, mobile phones, personal digital assistants (PDAs), digital cameras, camcorders, voice recorders, MP3 players, handheld personal computers, gamming devices, facsimiles, scanners, printers and the like, because flash memories are capable of electrically erasing data.

A flash memory can be configured in the form of a detachable memory card, such as a multimedia card (MMC), a Secure Digital (SD) card, a Smartmedia® card, a CompactFlash® card, and the like. A nonvolatile memory card, such as a flash memory can be inserted into and removed from a portable information apparatus by the user. With varieties of information apparatuses, the kinds of data, programs and operation modes stored in memory cards are being diversified. Therefore, new interfacing techniques are needed for effectively supporting such memory cards with various types of data, programming applications and operation modes.

An aspect of the present invention provides a data storage device including an external switch, a controller and a nonvolatile memory. The external switch selectively generates mode information in response to operation of the switch. The controller controls a recording operation of normal data and secured data in response to the mode information. The nonvolatile memory stores the normal data and the secured data in response to the controller.

The nonvolatile memory may store the mode information in association with at least one of the normal data and the secured data, respectively. The controller may analyze the mode information and control reading operations corresponding to the normal data and the secured data, respectively, based on the analyzed mode information. The mode information may be stored as metadata.

The secured data is accessible only by a permitted user, and the normal data is accessible by all users. The controller may limit access to the stored secured data to a permitted user based on one of an identification number input by a user, a unique number of the nonvolatile memory, and a number internally derived from the unique number. Also, the controller may include a crypto-processor configured to encrypt the secured data while the secured data is being stored.

The data storage devise may be configured as one of a multimedia card, a secure digital card, a Smartmedia® card, a Compactflash® card, a universal serial bus memory stick, and a solid state disk. The nonvolatile memory may be a flash memory.

Another aspect of the present invention provides an information processing system including a host and a data storage device for recording data in accordance with a request of the host. The data storage device includes an external switch, a controller and a nonvolatile memory. The external switch selectively generates mode information in response to operation of the switch. The controller controls a recording operation of normal data and secured data in response to the mode information. The nonvolatile memory stores the normal data and the secured data in response to the controller.

The secured data is accessible only by a permitted user. The permitted user may be enabled to access the secured data based on one of an identification number input from a user, a unique number of the nonvolatile memory, and a number internally generated from the unique number.

The host may include a first host configured to store the secured data and a second host configured to access the secured data. The first host enables the secured data to be stored without regard to whether a user is permitted to access the secured data. The second host enables a user to access the secured data only when the user is identified as being authorized to access the secured data.

The data storage device may be configured as one of a multimedia card, a secure digital card, a Smartmedia® card, a Compactflash® card, a universal serial bus memory stick, and a solid state disk.

Another aspect of the present invention provides a data management method for a data storage device, including setting a recording mode in response to operation of an externally accessible switch of the data storage device, and conducting one of a normal recording operation and a secured recording operation in accordance with the set recording mode.

Information indicating the set recording mode may be stored in the data storage device as metadata, while conducting one of the normal recording operation and the secured recording operation.

The method may further include analyzing the set recording mode corresponding to data subject to a read request from a host; outputting the read-requested data when the set recording mode is a normal mode; and determining whether a user is authorized when the set recording mode is a secured mode, and outputting the read-requested data only when the user is determined to be authorized.

Determining whether the user is authorized may be based on one of an identification number input by the user, a unique number associated with a nonvolatile memory of the data storage device, and a number internally generated from the unique number.

Accordingly, an operation mode (e.g., recording mode) may be easily changed by operation by a user of an external switch on a data storage device. Data may be stored as normal data or secured data by changing the operation mode. In particular, secured data reserved in the data storage device is selectively provided only to authorized users, improving data security.

### BRIEF DESCRIPTION OF THE DRAWINGS

The embodiments of the present invention will be described with reference to the attached figures, wherein like reference numerals refer to like parts throughout the various figures unless otherwise specified, in which:

FIG. 1 is a block diagram showing a data storage device, and an information processing system including the data storage device, according to an illustrative embodiment of the present invention;

FIGS. 2 through 5 are perspective views showing a mode selection switch and the data storage device, shown in FIG. 1, according to illustrative embodiments of the present invention;

FIG. 6 is a block diagram showing the data storage device of FIG. 5, according to an illustrative embodiment of the present invention;

FIG. 7 is a block diagram showing the data storage device of FIG. 5, according to an illustrative embodiment of the present invention;

FIG. 8 is a flow chart showing a method for storing normal/secured data in a data storage device, according to an illustrative embodiment of the present invention;

FIG. 9 is a flow chart showing a method for reading normal/secured data from a data storage device, according to an illustrative embodiment of the present invention; and

FIG. 10 is a flow chart showing a user identification process of steps S2300 and S2400 in FIG. 9, according to an illustrative embodiment of the present invention.

### DETAILED DESCRIPTION OF THE EMBODIMENTS

The present invention will now be described more fully with reference to the accompanying drawings, in which exemplary embodiments of the invention are shown. The invention, however, may be embodied in various different forms, and should not be construed as being limited only to the illustrated embodiments. Rather, these embodiments are provided as examples, to convey the concept of the invention to one skilled in the art. Accordingly, known processes, elements, and techniques are not described with respect to some of the embodiments of the present invention. Throughout the drawings and written description, like reference numerals will be used to refer to like or similar elements.

A data storage device, according to various embodiments of the present invention, includes an external switch configured to change a recording mode. A user operates the external switch to select a normal or secured mode for operations of the data storage device. Secured data stored in the data storage device during the secured mode is selectively provided only to an authorized user.

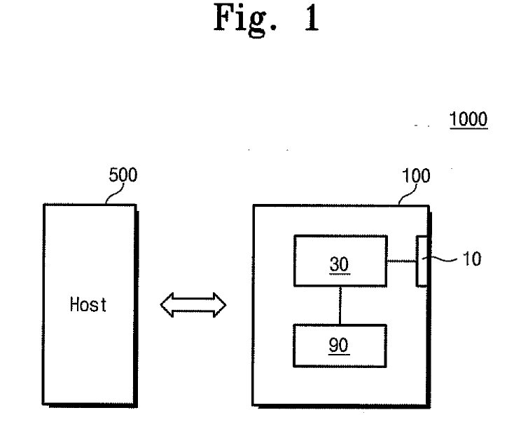

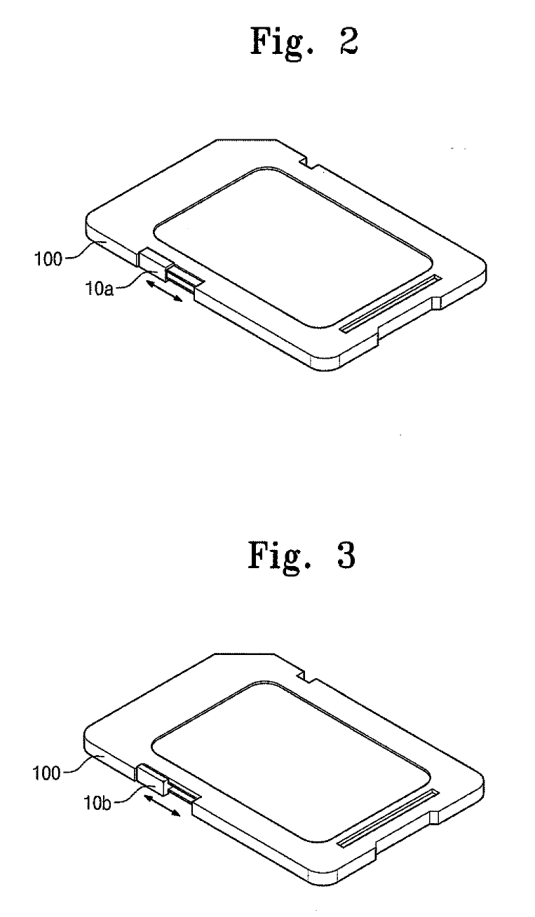

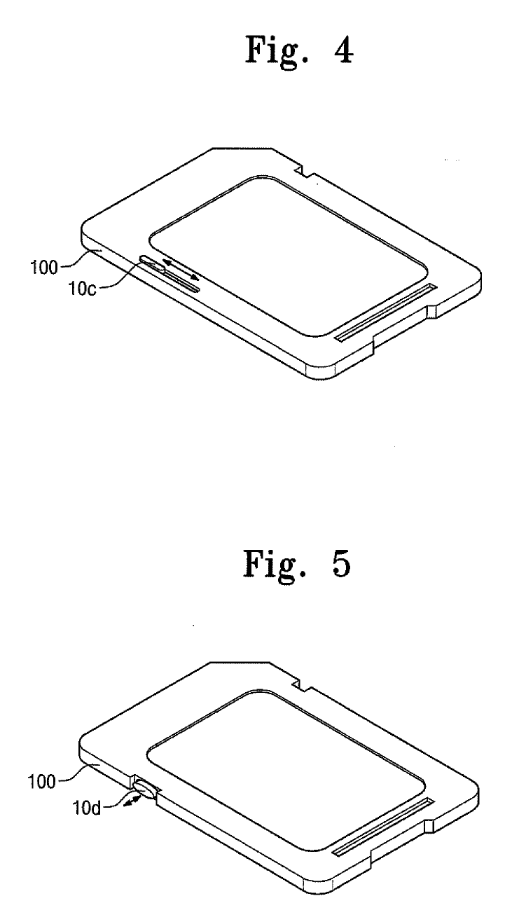

FIG. 1 is a block diagram showing a data storage device 100, according to an illustrative embodiment of the present invention, as well as an overall configuration of an information processing system 1000, which includes the data storage device. FIGS. 2 through 5 are perspective views showing external layouts of a mode selection switch 10 and representative data storage device 100 shown in FIG. 1, according to illustrative embodiments of the present invention.

Referring to FIG. 1, the data storage device 100 may be included in the information processing system 1000 together with a host 500. The data storage device 100 includes a mode selection switch 10, a controller 30 and a memory 90. The mode selection switch 10 is configured of external operation. The controller 30 sets a recording mode of the data storage device 100 to normal mode or secured mode in response to a mode signal generated in response to the position of the mode selection switch 10.

The mode selection switch 10 may have numerous configurations. For example, FIGS. 2 through 5 show representative configurations of the mode selection switch 10 as mode selection switches 10a, 10b, 10c and 10d, respectively, located on a face (side or topside) of the data storage device 100. According to various embodiments, the mode selection switches 10a˜10d may be a slide, toggle or push type switch. Although not shown in FIGS. 2 through 5, the mode selection switch 10 may also be implemented as any other type of switch, such as deep or rotary type switches, for example. In response to operation of the mode selection switch 10a, 10b, 10c or 10d (e.g., a sliding, toggling or pushing operation) by a user, a recording mode of the data storage device 100 is set to the normal mode or the secured mode. Data input to the data storage device 100 is stored as normal data or secured data, respectively, in accordance with the selected mode. Normal data refers to data that is accessible regardless of a user's authorization. Secured data refers to data that is accessible only by a user having authorization, referred to as a “permitted user.”

For example, secured data may correspond to personal data, data subject to a security clearance, or other sensitive or protected data. As stated above, secured data is selectively provided only to a permitted user, who must be identified (or authenticated). Thus, even when there are problems, such as loss of the data storage device 100, secured data stored in the data storage device 100 cannot be obtained by unauthorized or unauthenticated users. In contrast, there is no need to provide security protection for non-sensitive data, such as publically available data. Such data is stored in the data storage device 100 as normal data. Normal data are provided to any user, regardless of the user's authorization, identification or authentication. The data storage device 100 enables a data storage mode to be selected externally, e.g., using the mode selection switch 10a, 10b, 10c or 10d.

While the data storage device 100 is shown as a multimedia card (MMC), it will be understood that the data storage device 100 may alternatively be implemented as other type of data storage unit using nonvolatile memories as storage media, according to various embodiments. For example, the data storage device 100 may be fabricated in the form of a detachable card, e.g., an MMC, an SD card, a Smartmedia® card, a CompactFlash® card or the like. The data storage device 100 may likewise be implemented in a non-card form, such a universal serial bus (USB) memory stick or solid state disk (SSD), for example.

Referring again to FIG. 1, the controller 30 determines the recording mode in response to mode information generated or otherwise provided by the mode selection switch 10, and conducts a control operation for reading/writing/erasing data to and from the memory 90 in accordance with the determined recording mode. For instance, when the recording mode is set to the normal mode through operation of the mode selection switch 10, data input to the data storage device 100 is stored as normal data in the memory 90 in compliance with the controller 30. When the recording mode is set to the secured mode through operation of the mode selection switch 10, data input to the data storage device 100 is stored as secured data in the memory 90 in compliance with the controller 30.

In various embodiments, the memory 90 may be a flash memory, for example. As stated above, flash memory is able to retain data without power, and has high integration density. Because of these advantages, flash memory is useful for code storage, for saving contents that must be maintained regardless of power supply, as well as for data storage. Therefore, flash memory is often employed in a mobile unit, such as a cellular phone, PDA, digital camera, portable game console, or MP3 player, for example. Furthermore, flash memory may also be used in consumer applications, such as high definition TV, digital video disk (DVD), router, or global positioning system (GPS). However, embodiments of the present invention are not restricted flash memory, but rather are likewise applicable to other types of nonvolatile memories.

In addition, the number of the memor(ies) 90, the format and number of data storage areas included in the memory 90, and the configurations of memory cells forming the memory 90 (e.g., the number of bits per cell, the type memory cell, etc.), may vary. In an illustrative embodiment, the flash memory cells forming the memory 90 may include a type of various possible cell structures having charge storage layers. For example, the cell structure having charge storage layers may correspond to a charge-trap flash structure using charge trap layers, a stacked flash structure in which memories are stacked in multiple layers, a flash structure without source and drain, or a pinned flash structure.

As previously discussed, the controller 30 determines the recording mode in response to mode information provided by mode selection switch 10, and controls reading/writing/erasing operations in accordance with the determined recording mode and in response to an access request provided from the host 500. Additionally, the controller 30 manages mapping information of the memory 90, for example, by means of a flash translation layer (FTL), to cause the host 500 to utilize the data storage device 100 as a reservoir medium, such as a SRAM or HDD, to which the reading/writing/erasing operations are conducted without difficulty. Hereinafter, the FTL will be described as applied to a flash memory, although a file system of various embodiments is not restricted to the FTL.

The FTL may be implemented as independent hardware or by a device driver equipped in the system, for example. In an embodiment, a mapping result by the FTL is stored in the form of metadata. The metadata includes a variety of supplementary information, including information relating to the recording mode selected by the mode selection switch 10, in addition to an address mapping result. The metadata can be stored in a specific area of the memory 90 belonging to the data storage device 100, e.g., corresponding to normal and secured data, or evenly distributed over the memory 90. Therefore, there is flexibility to arranging areas for storing the metadata in the memory 90.

Secured data may be stored in the memory 90 with or without an encryption process. Encrypted and non-encrypted data can be indicated as secured data through the corresponding metadata. Data set to secured data is not accessible by general (unauthorized) users, but rather is accessible only by permitted (authorized) users, through a process of user identification and/or authentication. Processes for encrypting secured data and conducting user identification and/or authentication may be conducted according to various techniques.

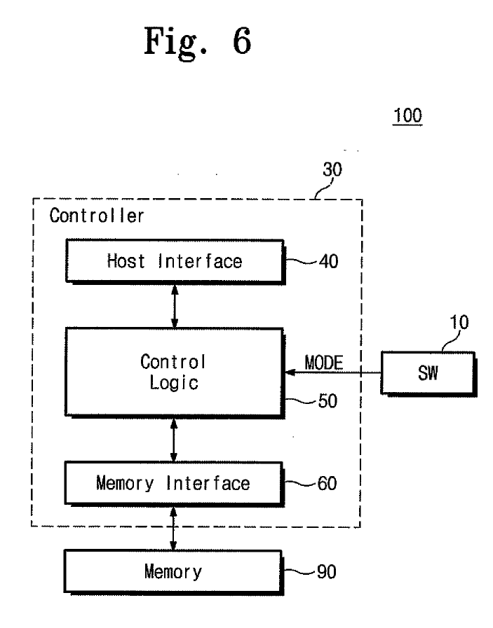

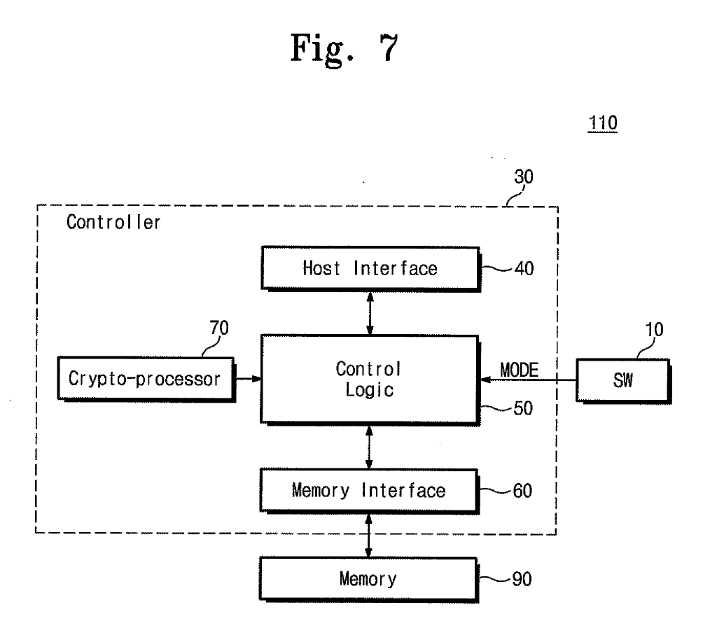

FIGS. 6 and 7 are block diagrams showing configurations of the data storage device 100, shown in FIG. 5, according to illustrative embodiments of the present invention. More particularly, FIG. 6 shows a configuration of the data storage device 100 in which the controller 30 does not have a crypto-processor, and FIG. 7 shows a configuration of the data storage device 100 in which the controller 30 includes a crypto-processor 70.

Referring to FIG. 6, the data storage device 100 includes the mode selection switch 10, the controller 30 and the memory 90. The controller 30 includes a host interface 40, a control logic circuit 50 and a memory interface 60.

The host interface 40 conducts an intermediate operation (i.e., interfacing operation) between the control logic circuit 50 and the host 500. The host interface 40 may be configured to communicate using various interface protocols, such as USB, MMC, peripheral component interconnection bus-express (PCI-E), advanced technology attachment (ATA), serial-ATA, parallel-ATA, small computer system interface (SCSI), SAS (Serial Attached SCSI), enhanced small device interface (ESDI), and integrated driver electronics (IDE). The memory interface 60 conducts an intermediate operation between the control logic circuit 50 and the memory 90. The memory interface 60 operates in accordance with an interface mode determined by the type of the memory 90.

The control logic circuit 50 conducts reading/writing operations and data management by FTL to the memory 90 in compliance with a request by the host 500. The control logic circuit 50 is connected to the mode selection switch 10. The control logic circuit 50 determines whether the recording mode has been set to the normal mode or the secured mode in response to a mode signal MODE provided by the mode selection switch 10 based on an operation of the mode selection switch 10 by a user. Normal data input during the normal mode is stored in a normal field of the memory 90 by the control logic circuit 50. Secured data input during the secured mode is stored in a secured field of the memory 90 by the control logic circuit 50. The normal and secured fields of the memory 90 may be physically divided or uniformly distributed over the memory 90. Formations of the normal and secured fields of the memory 90 vary within many possible configurations. In an embodiment, information for address mapping and recording mode of the normal and secured data stored in the memory 90 is stored in the form of metadata by the control logic circuit 50. The metadata may be reserved in the same data storage area with the normal and secured data, respectively, or in an additional data storage area.

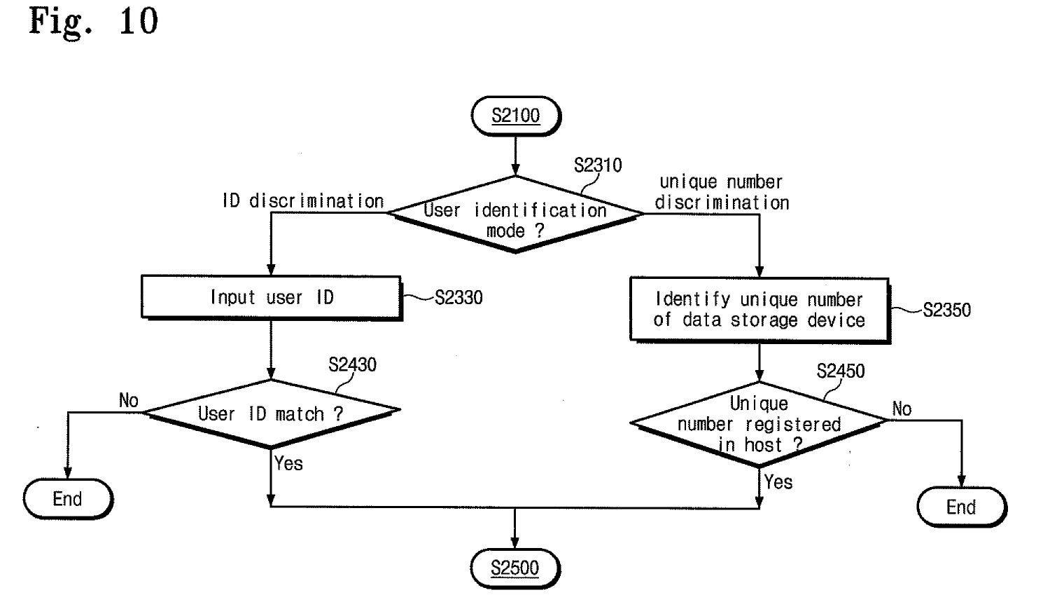

When there is a read request by the host 500, the control logic circuit 50 analyzes the stored metadata and determines whether the corresponding data is normal or secured data. Normal data stored in the normal field may be provided to all users regardless of user identification, authorization or authentication. However, secured data stored in the secured field is selectively provided only to a permitted authorized user who is properly authenticated. Whether a user is a permitted user is determined through an additional user identification process, described below with respect to FIG. 10.

Referring to FIG. 7, the data storage device 110 is substantially the same as the data storage device 100 shown in FIG. 6, except that the controller 30 is includes the crypto-processor 70. The same components are referred to by the same reference numerals, and the descriptions will not be duplicated.

As illustrated in FIG. 7, the crypto-processor 70 is associated with the control logic circuit 50. The crypto-processor 70 is configured to perform an encryption function to encrypt the secured data, so that the secured data stored in the secured field is protected, for example, from external power attack. The encryption may be performed in accordance with any known encryption algorithm. Encrypted secured data is stored in the secured field of the memory 90 by the control logic circuit 50. In an alternative embodiment, encryption may be performed on the normal data, as well as the secured data.

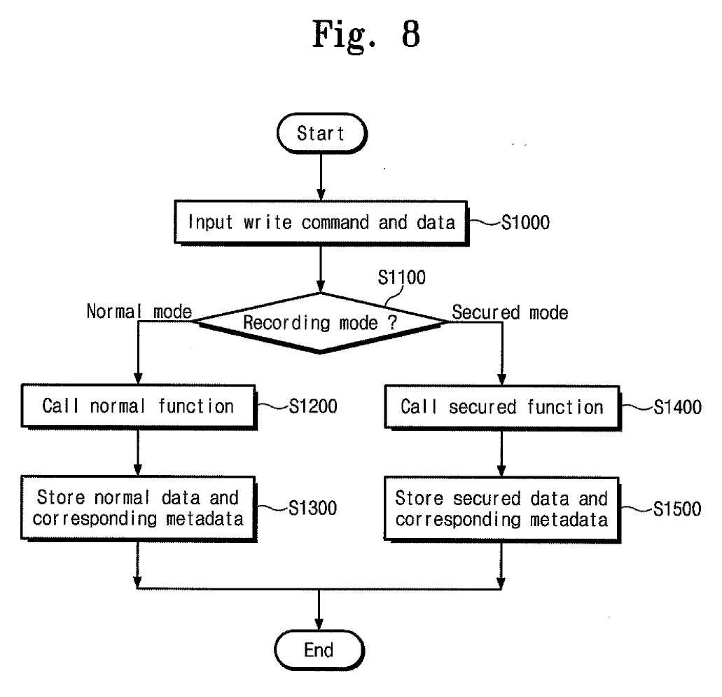

Methods of storing normal and secured data in the data storage device 100, reading the normal and secured data from the data storage device 100, and identifying a permitted user are described below, with reference to FIGS. 8 through 10, respectively.

FIG. 8 is a flow chart showing a method for storing normal/secured data in the data storage device 100, according to an illustrative embodiment of the present invention.

Referring to FIG. 8, to record data in the data storage device 100, the data storage device 100 first accepts a write command and data from the host 500 (step S1000). Then, it is determined whether a recording mode of the data storage device 100 has been set to the normal or secured mode (step S1100). The recording mode of the data storage device 100 is determined in response to the mode signal MODE generated from the mode selection switch 10 based on the user's handling. As shown in FIGS. 2 through 5, since the mode selection switch 10 is configured to be easily operated externally, it is easy for the user to set and change the recording mode.

Based on the result of the determination in step S1100, when the recording mode of the data storage device 100 is determined to be the normal mode, a request (or call) of a normal function is generated for the normal recording mode (step S1200). In response to the call of the normal recording mode, normal data and corresponding metadata are stored in the memory 90 (step S1300). An area of the memory 90 in which normal data is stored is referred to as the normal field. On the other hand, when the recording mode of the data storage device 100 is determined to be the secured mode, a call of a secured function is generated for the secured recoding mode (step S1400). In response to the call of the secured recording mode, secured data and corresponding metadata are stored in the memory 90 (step S1500). An area of the memory 90 in which secured data is stored is referred to as the secured field.

As discussed above, the normal and secured fields of the memory 90 may be physically divided from each other or uniformly distributed over the entire area of the memory 90 without physical division. Configurations of the normal and secured fields of the memory 90 may vary. Information about address mapping and recording mode of normal and secured data stored in the memory 90 may be stored in the form of metadata. In alternative embodiments, the metadata is stored in the same data storage area with associated normal or secured data, or is stored in an additional data storage area.

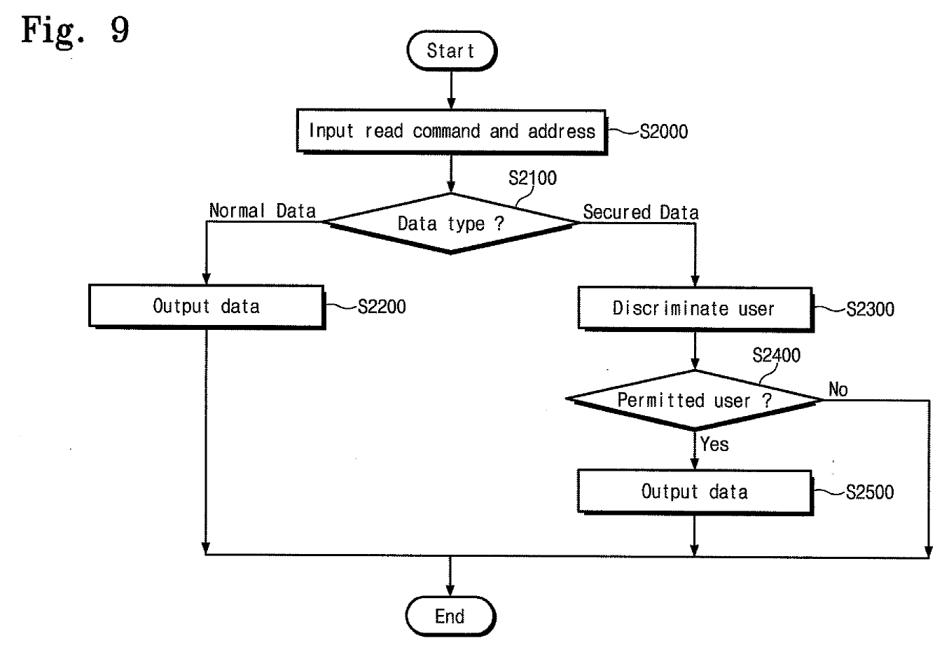

FIG. 9 is a flow chart showing a method for reading normal/secured data from the data storage device 100, according to an illustrative embodiment of the present invention.

Referring to FIG. 9, to read out normal/secured data from the data storage device 100, the data storage device 100 receives a read command and address from the host 500 (step S2000). Then, it is determined whether the data requested by the host 500 is normal or secured data (step S2100). The type of data stored in the data storage device 100 may be differentiated with reference to recording mode information contained in corresponding metadata, as discussed above.

When the determination result of step S2100 indicates that the data requested by the host 500 is normal data, the data is output (step S2200). However, when the determination result of step S2100 indicates that data requested by the host 500 is secured data, an identification operation is carried out to determine whether the current user is a permitted user authorized to access the secured data (step S2300). From a result of the determination by step S2300, when the current user is authorized, the data requested by the host 500 is output from the memory 50 (step S2500). When the current user is not authorized, as determined in step S2300, the procedure is terminated without outputting the data requested by the host 500.

FIG. 10 is a flow chart showing a method for identifying a user, depicted in steps S2300 and S2400 in FIG. 9, for example, according to an exemplary embodiment of the present invention.

Referring to FIG. 10, a user identification mode is first determined (step S2310). The user identification mode may be implemented using various user identification techniques. In the depicted embodiment, the possible user identification modes include discriminating identification (ID) of the user and discriminating a unique number (e.g., product number) of the data storage device 100.

For instance, when the host 500 has an associated data input unit, such a keyboard or keypad, the discriminating ID mode may be used. The host 500 having an input unit may be a computer, mobile phone, PDA, handheld PC, or gaming machine, for example. The ID of a permitted user may be stored in the host 500 and/or the data storage device 100.

To identify a permitted user, a user ID is input through the input unit (step S2330), and compared with one or more permitted user IDs (step S2430), previously stored in the host 500 and/or data storage device 100. It is determined whether the input user ID matches one of the permitted user IDs (step S2430). When the input user ID matches a permitted user ID, the process goes to step S2500, in which the secured data requested by the host 500 is output to the user. However, when it is determined in step 2430 that the input user ID does not match any permitted user ID, the process is terminated. In various embodiments, the ID discrimination process is performed by the controller 30 of the data storage device 100 or by the host 500. Also, in an embodiment the user may be further authenticated when input user ID matches the permitted user ID, for example, based on addition authentication information.

When the host 500 does not include a data input unit, such as keyboard or keypad, the mode of discriminating a unique number of the data storage device 100 is employed for user identification. Examples of a host 500 not having an input unit include a camera, a camcorder, a voice recorder, an MP3 player and the like.

To identify a permitted user by referring a unique number of the data storage device 100, the unique number is read from an area of the memory 90, in which the unique number has been previously stored (step S2350). For example, the data storage device 100 may be supplied with its own unique number while being manufactured. The unique number (e.g., product number or ID) is stored in a hidden area that cannot be arbitrarily overwritten or erased by a general user. The hidden area may also have information regarding the version of the memory, etc., in addition to the unique number. Although not shown in FIG. 10, in order to perform the user identification using the unique number of the data storage device 100, the unique number of the data storage device 100 must be previously registered in the host 500. The user identification using the unique number of the data storage device 100 is conducted by the host 500.

A unique number of the data storage device 100, which is read during step S2350, is compared to the unique number previously registered in the host 500. It is determined whether the read and previously registered unique numbers match one another (step S2450). When the read two unique numbers match, the process goes to step S2500 for outputting the secured data requested by the host 500 to the corresponding user. However, when step S2450 determines that the two unique numbers do not match, the process is terminated.

In various embodiments, the comparison operation of step S2450 is not performed using only the unique number of the data storage device 100. For example, the comparison may be conducted by means of a value (e.g., hash value) derived from the unique number. For example, when a unique number of a card is read and provided directly to the host 500, there is a risk of exposing the otherwise secret unique number. To prevent such an exposure, an embodiment of the present invention provides a function for discriminating the user by mutually transceiving an internal value of the host 500 and the value (e.g., hash value) derived from the unique number of the data storage device 100, under a predetermined protocol, between the data storage device 100 and the host 500.

While the embodiment depicted in FIG. 10 outputs secured data to a corresponding user when a unique number of the data storage device 100 is identical to the unique number registered in the host 500, alternative embodiments may be variously implemented.

For instance, the host 500 may be divided into two types of hosts, one for storing secured data and one for outputting secured data from storage. In this case, the host storing secured data is referred to as “first host,” and the host outputting secured data is referred to as “second host.” The first host may be a portable information processing device, such as digital camera, camcorder, voice recorder, or the like, and the second host may be a large-capacity data processor, such as a computer, PDA, handheld PC, or the like, which backs-up and replays data stored by the first host.

The first host is able to conduct functions of storing normal and secured data in the data storage device 100 in accordance with a recording mode of the data storage device 100, and accessing the normal data from the data storage device 100. The secured data stored in the data storage data 100 cannot be accessed by the first host, but is accessible only by the second host, specifically assigned thereto. To regulate the access, a unique number of the data storage device 100 is preliminarily registered in the second host. Then, the second host accesses the secured data from the data storage device 100 having a unique number that has been registered. In other words, the secured data stored in the data storage device 100 is accessible only by the second host in which the unique number of the data storage device 100 has already been registered.

The second host determines whether the data storage device 100 has been registered in accordance with the process of steps S2350 and S2450 shown in FIG. 10, for example. When the data storage device 100 is identified as being registered, the second host accesses the normal and secured data from the data storage device. When the data storage device 100 is identified as not being registered in the second host, the second host only accesses the normal data from the data storage device 100.

As previously discussed, the data storage device 100 includes the mode selection switch 10, which enables a recording mode to be changed externally. The user is thus able to store data in the data storage device 100 as normal or secured data by operating the externally accessible mode selection switch 10, located outside the data storage device. The authority to store normal data or secured data in the data storage device 100, and to read normal data and secured data from the data storage device 100, may be granted differently by first and second hosts.

For example, the first host may be configured to grant the authority to permitted or non-permitted users (i.e., authorized or unauthorized users) for storing normal and secured data. However, with the first host, there is no discrimination between permitted and non-permitted users in recording the secured data. Accordingly, the data storage device 100 is adaptable to a generic host, e.g., which does not provide the function of securing data or discriminating a user. In this case, the first host is capable of rendering the normal data to be provided to all users without discrimination, but cannot render the secure data to only permitted users. The second host is configured to grant authority only to permitted users with respect to secured data. In this case, the second host is capable of rendering the normal data to be provided to all users without discrimination, while rendering the secured data only to permitted users.

As stated above, the data storage device 100 includes an external mode selection switch 10. However, the configurations discussed herein are illustrative, and variations may be included in additional embodiments. For instance, the mode selection switch 10 may be included on the host 500, to which the data storage device 100 links. In this case, the user is able to easily set a recording mode of the data storage device 100 to the normal mode or the secured mode by operating the mode selection switch installed at the host 500. The mode signal MODE from the mode selection switch at the host 500 may be provided to the controller 30 by way of the host interface 40 of the data storage device 100, for example. According to this configuration, there is no need to remove or otherwise disconnect the data storage device 100 from the host 500 in order to operate the mode selection switch 10.

Also, while the preceding description is directed to setting or changing a recording mode using the mode selection switch 10, externally located at the data storage device 100 or the host 500, various alternative embodiments are not restricted to setting or changing only the recording mode. For example, the mode selection switch 10 may be used for externally setting or changing various operation modes of the data storage device 100 or the host 500.

while the present invention has been shown and described in connection with exemplary embodiments thereof, it will be apparent to those skilled in the art that various modifications can be made without departing from the spirt and scope of the invention as defined by the appended claims.

What is claimed is:

1. A data storage device comprising:
an external switch selectively generating mode information in response to operation of the switch;
a controller controlling a recording operation of normal data and secured data in response to the mode information; and
a nonvolatile memory storing the normal data and the secured data in response to the controller.

2. The data storage device of claim 1, wherein the nonvolatile memory stores the mode information in association with at least one of the normal data and the secured data, respectively.

3. The data storage device of claim 2, wherein the controller analyzes the mode information and controls reading operations corresponding to the normal data and the secured data, respectively, based on the analyzed mode information.

4. The data storage device of claim 2, wherein the mode information is stored as metadata.

5. The data storage device of claim 1, wherein the secured data is accessible only by a permitted user.

6. The data storage device of claim 1, wherein the normal data is accessible by all users.

7. The data storage device of claim 1, wherein the controller limits access to the stored secured data to a permitted user based on one of an identification number input by a user, a unique number of the nonvolatile memory, and a number internally derived from the unique number.

8. The data storage device of claim 1, wherein the controller comprises a crypto-processor configured to encrypt the secured data while the secured data is being stored.

9. The data storage device of claim 1, wherein the data storage devise is configured as one of a multimedia card, a secure digital card, a universal serial bus memory stick, and a solid state disk.

10. An information processing system comprising:
a host; and
a data storage device recording data in accordance with a request of the host, the data storage device comprising:
an external switch selectively generating mode information in response to operation of the switch;
a controller controlling a recording operation of normal data and secured data in response to the mode information; and
a nonvolatile memory storing the normal data and the secured data in response to the controller.

11. The information processing system of claim 10, wherein the secured data is accessible only by a permitted user.

12. The information processing system of claim 11, wherein the permitted user is enabled to access the secured data based on one of an identification number input from a user, a unique number of the nonvolatile memory, and a number internally generated from the unique number.

13. The information processing system of claim 11, wherein the host comprises a first host configured to store the secured data and a second host configured to access the secured data.

14. The information processing system of claim 13, wherein the first host enables the secured data to be stored without regard to whether a user is permitted to access the secured data.

15. The information processing system of claim 13, wherein the second host enables a user to access the secured data only when the user is identified as being authorized to access the secured data.

16. The information processing system of claim 10, wherein the data storage device comprises one of a multimedia card, a secure digital card, a universal serial bus memory stick, and a solid state disk.

17. A data management method for a data storage device, comprising:
setting a recording mode in response to operation of an externally accessible switch of the data storage device; and
conducting one of a normal recording operation and a secured recording operation in accordance with the set recording mode.

18. The method of claim 17, wherein information indicating the set recording mode is stored in the data storage device as metadata, while conducting one of the normal recording operation and the secured recording operation.

19. The method of claim 18, fierier comprising:
analyzing the set recording mode corresponding to data subject to a read request from a host;
outputting the read-requested data when the set recording mode is a normal mode; and
determining whether a user is authorized when the set recording mode is a secured mode, and outputting the read-requested data only when the user is determined to be authorized.

20. The method of claim 19, wherein determining whether the user is authorized is based on one of an identification number input by the user, a unique number associated with a nonvolatile memory of the data storage device, and a number internally generated from the unique number.
